(19) United States
(12) Patent Application Publication
(10) Pub. No.: US 2002/0185299 A1
(43) Pub. Date: Dec. 12, 2002

(54) Underwater cable

(76) Inventor: Wolfgang Giebel, Planegg (DE)

Correspondence Address: TECHNOPROP COLTON, L.L.C., P O BOX 567685, ATLANTA, GA, 311567685

(21) Appl. No.: 10/207,338

(22) Filed: Jul. 29, 2002

Related U.S. Application Data
(63) Continuation-in-part of application No. 09/521,705, filed on Mar. 9, 2000, now Pat. No. 6,437,248.

(30) Foreign Application Priority Data
Mar. 10, 1999 (DE) 199 10 708.4
Jun. 22, 1999 (DE) 199 28 506.3

(51) Int. Cl. H01B 7/00

(52) U.S. Cl. 174/110 R

(57) ABSTRACT

An underwater or submarine cable (10) having an outer sheath (11) of a first color and a marking of a second color that stands out from the outer sheath (11) that makes the cable more easily visible, with the marking and the outer sheath (11) being formed contemporaneously over the inner core of the cable (10).

### STATEMENT OF RELATED APPLICATIONS

This patent application is a continuation-in-part application of U.S. application Ser. No. No. 09/521705, filed on Mar. 9, 2000, currently pending and allowed.

### BACKGROUND OF THE INVENTION

1. Technical Field

The invention concerns a cable, in particular an underwater cable, with a cable core having at least one conductor, and an outer sheath formed contemporaneously of two colors.

2. Prior Art

Underwater cables (so-called submarine cables) must be observed during laying, for inspection purposes and for tracing any defects. This takes place under water with remote-controlled cameras. The pictures taken by the cameras under water, in particular at great depths, often allow the underwater cable to be made out only with difficultly, in particular whenever it has a customary black or dark outer sheath. This makes it difficult in particular to locate defective underwater cables.

Various two-color wire and cables are known. However, such known two-color devices do not relate to the underwater and undersea fields, which is a specific species of cable necessarily having specific properties unlike and not anticipated by the properties of general two-color cables. One such specific property is the need for higher integrity for the cable to withstand the underwater environment.

Some examples of the known art are cables or hoses made of rubber that are provided with colored identification markings. The markings are imparted to the hoses by placing a label strip (a stencil) onto the cable and subjecting both of them to a lead bath process. The lead bath coats the cable with a layer of lead, thus pressing the strip into the rubber of the cable. One disadvantage of this process is that the strip is a foreign body that is now part of the cable. First, the strip can dislodge. Second, the strip creates a weaker point on the outer sheath (the interface between two different materials creates a weaker point, which typically is the site for failure of the substrate material). Third, by pressing the strip into the outer sheath, the thickness of the outer sheath is reduced. Overall, the integrity of the cable is compromised, which is highly undesirable for an underwater cable in general, and anathema for an undersea cable in specific.

The known art further teaches the use of a thin strip of material (such as paper) having a coating on one side made of a rubber mixture for forming the marking. This strip is fed continuously with the cable and pressed into the cable during a vulcanization process so that the rubber coating of the strip forms a bond with the cable sheath material. This also introduces a foreign body to the cable, thus compromising integrity. The presence of the rubber coating on the paper strip does not alter this—the rubber coating only promotes vulcanization of the strip with the sheath material. Specifically, after the strip has been vulcanized to the cable, there is the risk that, during subsequent operation of the cable, the layer formed by the paper may become dislodged. In the underwater setting, this can have disastrous effects. In particular, if the conducting core is compromised by water, the core can easily become compromised itself (for example, rust) or electrically short out.

Other examples of the known art involve the spraying on of various marking to the outer sheath of a finished cable. It is well known that sprayed on markings are not as resistant as markings made of the same material as the sheath. Even more specifically, when the markings are the same material as the sheath, the resistance is greater than markings of a disparate material. Generally, the type of cables on which the various markings are sprayed include telecommunications cables or switching wires for telephone installations, which are not underwater cables and do not need the integrity needed by underwater cables.

Thus, it can be seen that there is a need for an underwater or undersea cable that comprises an outer sheath of two colors, one that stands out from the other, yet still maintains a sufficient level of structural integrity in the underwater or undersea environment. It is to this need, among other needs, that the present invention is directed.

### BRIEF SUMMARY OF THE INVENTION

Setting out from the above situation, the invention is based on the object of providing a cable, in particular an underwater cable (submarine cable), which can be made out well under water, even at great depths.

A cable serving to achieve this object, in particular an underwater cable or submarine cable, has a cable core having at least one conductor, and an outer sheath. At least one externally visible marking of a different color on the outer sheath makes the cable more easily visible, in particular in the underwater area. The underwater cable according to the invention can be made out more easily on camera pictures, because the marking of the different color provides the outer sheath with greater contrast.

The marking can be formed in a wide variety of ways. The marking preferable consists of one or more strips or lines extending continuously in the longitudinal direction of the outer sheath of the cable and preferably extending spirally around the cable. The marking comprising one or more spiral longitudinal strips or longitudinal lines on the outer sheath has the effect that the marking is always visible, irrespective of from which side the cable viewed. Since submarine cables turn about their longitudinal axis during laying, the longitudinal strips or longitudinal lines likewise running spirally around the longitudinal axis of the submarine cable represent a marking that is virtually always visible.

It is alternatively also conceivable to form the marking by traverse strips or transverse lines running in a cross-sectional direction around the cable. These are then virtually endless, colored rings around the outer sheath. They are also always visible, irrespective of any turning of the cable. Like the abovementioned longitudinal lines or longitudinal strips extending spirally around the cable, the peripheral transverse trips or transverse lines have the advantage that turning of the submarine cable during laying does not become visible and as a result does not disturb the viewer.

It is likewise conceivable to form the marking from straight longitudinal strips or longitudinal lines. In order that a straight longitudinal strip or longitudinal line is always visible in each case, a corresponding number of longitudinal strips or longitudinal lines are arranged evenly distributed on the circumference of the outer sheath. The longitudinal strips or longitudinal lines or transverse strips or transverse lines can also be produced from at least one series of two-dimensional formations following one another at intervals. The two-dimensional formations may have any desired base areas, and in particular be round, elliptical, square or rectangular. Similarly, the intervals between the two-dimensional formations may be as desired.

Finally, it is also conceivable to provide the entire outer sheath with a marking comprising dots of any desired shape. In this case, the dots are arranged in a uniform grid, which preferably extends over the entire circumference of the outer sheath. Such a grid also has the advantage that marking is always visible and turns of the submarine cable during laying do not become evident and do not in this case detract from the observation of laying.

Any type of marking can be formed by a dye sprayed or printed onto the outer sheath after it has been produced. For this purpose, a dye that is permanently resistant to seawater is used. It is also conceivable, after applying the dye forming the marking, to provide the entire outer sheath with a transparent protective layer, which also covers the colored marking.

It is also possible to form the marking from a plastic of a different color during the production of the outer sheath. The outer sheath is then made up of differently colored plastic materials. For example, this can be achieved by coextrusion of the outer sheath or by sintering the plastic of a different color onto the surface of the outer sheath. The types of marking mentioned then have virtually the same seawater resistance as the outer sheath.

According to a preferred embodiment of the invention, the respective marking has a lighter color than the outer sheath. It is also advantageous if the lighter color of the marking has fluorescent properties. As a result, the marking of the submarine cable becomes visible even at great depths if searchlights of an underwater camera shine on it. In the case of submarine cables with a usually black outer sheath cable, a yellow color, in particular a fluorescent yellow color that offers easily visible contrast together with the black color of the outer sheath, is preferably chosen for the lighter color of the marking.

The marking may also be formed by mixing color particles or color pigments in with the raw material of the plastic for forming the outer sheath. Such an outer sheath then has an essentially regular distribution of colored locations, in particular smaller dots. The embedding of the color particles or color pigments in the plastic material for forming the outer sheath ensures a permanent bonding of the marking to the submarine cable.

In an alternative embodiment of the submarine cable according to the invention, the marking is formed by a netting applied to the outer sheath. The netting surrounds the entire outer sheath and extends uninterruptedly in the longitudinal direction of the submarine cable. The netting produces on the outside of the outer sheath of the submarine cable peripheral transverse strands and rectilinear longitudinal strands with preferably a round cross section, although other cross sections, for example square, are also conceivable. If the netting is of a different color, the crossing longitudinal and transverse strands form the marking.

Thus, as can be seen, the present invention is an underwater cable necessarily having specific differences from other cables and the known art not subject to the underwater environment.

### BRIEF SUMMARY OF THE DRAWINGS

Preferred exemplary embodiments of the cable according to the invention are explained in more detail below with reference to the drawings, in which:

FIG. 1 shows a side view of a portion of a submarine cable according to a first exemplary embodiment of the invention.

FIG. 2 shows a side view of a portion of a submarine cable according to a second exemplary embodiment of the invention.

FIG. 3 shows a side view of the submarine cable of FIG. 2 turned through 90° with respect to FIG. 2.

FIG. 4 shows a side view of a portion of a submarine cable according to a third exemplary embodiment of the invention.

FIG. 5 shows a side view of the submarine cable of FIG. 4 turned through 90° with respect to FIG. 4.

FIG. 6 shows a side view of a portion of a submarine cable according to a fourth exemplary embodiment of the invention.

FIG. 7 shows a side view of a portion of a submarine cable according to a fifth exemplary embodiment of the invention.

FIG. 8 shows a cross-sectional view of the second exemplary embodiment of the present invention shown in FIGS. 2 and 3 along line 8-8′.

### DETAILED DESCRIPTION OF THE PREFERRED EMBODIMENTS

The figures show cables for underwater use, namely, submarine cables of any desired construction. In particular, the submarines cables may have in the interior a core of any desired construction. For example, the core may have both electrical conductors and optical waveguides or combinations of the two. In addition, the core has at least one armoring or reinforcement for protection against mechanical influences. The core with the reinforcement or armoring is surrounded by a closed outer sheath, which consists essentially of plastic. The outer sheathe is usually black.

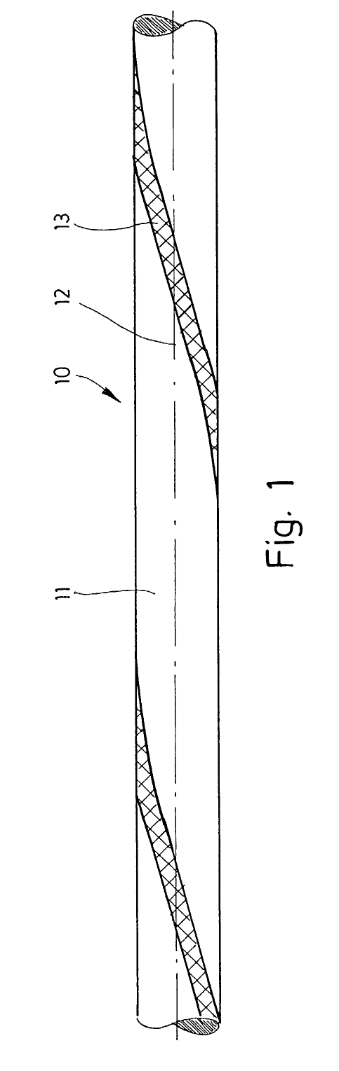

FIG. 1 shows a submarine cable 10, the outer sheath 11 of which is provided with an externally visible marking. In the exemplary embodiment shown, the marking is formed by a longitudinal strip 13 running spirally around the outer sheath 11 in the longitudinal direction, in other words along the longitudinal center axis 12 of the submarine cable 10. The single longitudinal strip 13 in the exemplary embodiment of FIG. 1 has, depending on the diameter of the submarine cable 10, a width of between 1 and 5 mm. The longitudinal strip 13 preferably has width that corresponds approximately to one-quarter to one-fifth of the diameter of the submarine cable 10. In the exemplary embodiment shown, the pitch of the spiral helix of the longitudinal strip 13 around the submarine cable 10 is chosen such that, over a length of the submarine cable 10 which is approximately three to ten times, preferably approximately eight times, the diameter of the said cable, the longitudinal strip 13 has run once around the outer sheath 11 of the submarine cable 10.

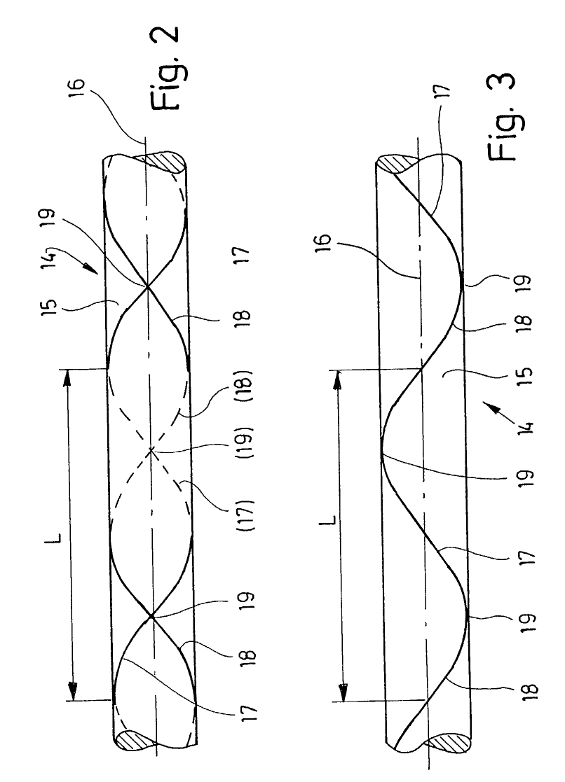

FIGS. 2 and 3 show a submarine cable 14 according to a second exemplary embodiment of the invention. The internals of the submarine cable 14, which may be of any desired construction, are not represented in any more detail in the figures mentioned (or in any of the other figures). Only the outer sheath 15 with markings according to the invention is shown. In the present exemplary embodiment as well, the marking is formed by longitudinal strips running in a serpentine manner around the outer sheath 15 along the longitudinal center axis 16, to be precise, two longitudinal strips 17, 18. For reasons of simple representation, the longitudinal strips 17, 18 are only indicated by lines. In fact, they have a width that, depending on the diameter of the submarine cable 14, may be between 1 and 5 mm. It is also conceivable to make the individual longitudinal strips 17, 18 of different widths.

The two longitudinal strips 17, 18 run in different direction around the outer sheath 15. While the longitudinal strip 17 snakes clockwise around the outer sheath 15, the longitudinal strip 18 runs anticlockwise around the outer sheath 15. Both longitudinal strips 17, 18 have the same pitch, which is indicated in FIGS. 2 and 3 by the dimensions L. This means that, on a portion L of the submarine cable 14, the longitudinal strip 17 wraps once right round the submarine cable 14 in one direction and the longitudinal strip 18 wraps once right around the submarine cable 14 in the other direction.

The longitudinal strips 17, 18, which follow an identical path, cross at common nodes 19, the intervals of which have half the dimension L of a complete revolution of the respective longitudinal strip 17, 18 around the outer sheath 15.

The design and arrangement described of the longitudinal strips 17, 18 on the submarine cable 14 have the effect that, depending o the viewing direction towards the side of the submarine cable 14, the two oppositely running longitudinal strips 17, 18 have different paths. It can be seen from the representation in FIG. 2 that both longitudinal strips 17, 18 are simultaneously visible in the same region of the length of the submarine cable 14. Between two successive visible portions of the longitudinal strips 17, 18, both longitudinal strips 17, 18 disappear entirely to the invisible rear side of the submarine cable 14. The length of this invisible region is half the length of one complete revolution of the respective longitudinal strip 17, 18 around the submarine cable 14. If the submarine cable 14 represented in FIG. 2 is viewed from below, one of the two longitudinal strips 17, 18 is always visible. The serpentine or sinusoidal path shown in the figure is thereby obtained. Thus, from certain views of the submarine cable 14, the two longitudinal strips 17, 18 extending in opposite directions have the effect that either only a single longitudinal strip 17, 18 is visible or both longitudinal strips 17, 18 are only partially visible.

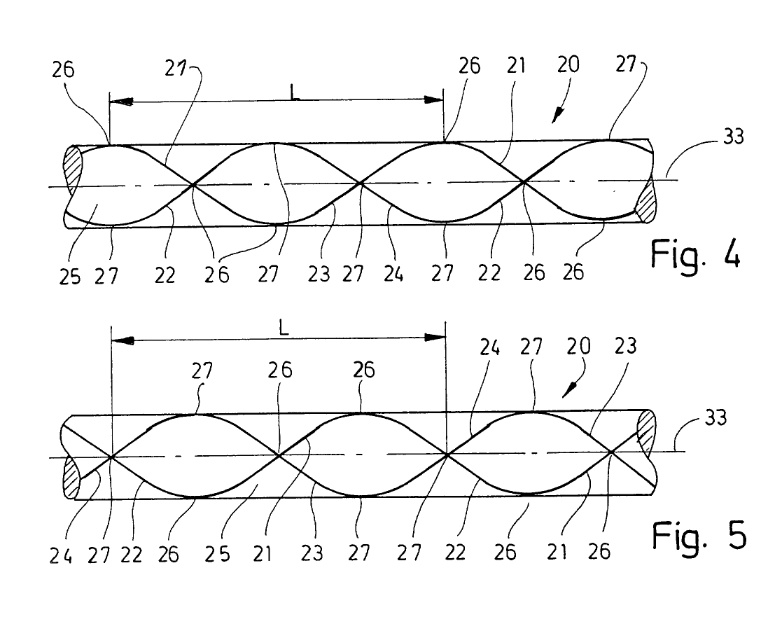

FIGS. 4 and 5 show a third exemplary embodiment of a submarine cable 20, in which the marking has four longitudinal strips 21 to 24. The longitudinal strips 21, 22 correspond to the longitudinal strips 17, 18 of the exemplary embodiment of FIGS. 2 and 3. The longitudinal strips 21, 22 become visible in the left-hand half of the dimension L of FIG. 4. Located invisibly behind them, which the same path, are the longitudinal strips 23, 24. In the right-hand half of the dimension L in FIG. 4, the longitudinal strips 21, 22 disappear invisibly to the rear side of the outer sheath 25 of the submarine cable 20. In this region, the longitudinal strips 23, 24 appear visibly on the front side of the outer sheath 25. Behind the dimension L in FIG. 4, these strips disappear again to the rear side of the outer sheath 25 and the longitudinal strips 21, 22 visibly reemerge.

The longitudinal strips 21, 22 on the one hand and the longitudinal strips 23, 24 on the other hand are all of the same design as one another. The longitudinal strips 21, 22, 23, 34 wrap around the outer sheath 25 in the direction of the longitudinal center axis 32 of the submarine cable 20. The only difference that, at the upper (left-hand) node 26 in FIG. 4, the longitudinal strip 21 begins in one direction and the longitudinal strip 23 begins in another direction. Extending from the node 27 lying below it in FIG. 4 are the longitudinal strips 22, 24, to be precise in such a way that they wrap around the submarine cable 20 in opposite directions. As a result, there are always two nodes 26, 27 diametrically opposite one another on the outer sheath 25 of the submarine cable 20. The nodes 26, 27 are always offset by the dimension L-quarter in the direction of the longitudinal center axis 16 of the submarine cable 20 and also always turned through 90°.

The four longitudinal strips 21, 22, 23, 24, which are of the same design and are just directed differently, or extend from different nodes 26, 27, achieve the effect that the marking of the outer sheath 25 is continuously visible from every side of the submarine cable 20, to be precise with the same pattern, as clearly illustrated by FIGS. 4 and 5, which show the submarine cable 20 from two viewing directions respectively offset by 90°.

The longitudinal strips 21, 22, 23, 24, again shown only as lines in FIGS. 4 and 5 for reasons of simplification, are in fact designed as wider strips, to be precise with a width of preferably 1 to 5 mm. In the case of relatively thick submarine cables 20, the strips may be even wider. The same also applies to the other exemplary embodiments of the invention. It is conceivable to make the individual longitudinal strips 21, 22, 23, 24 of different widths.

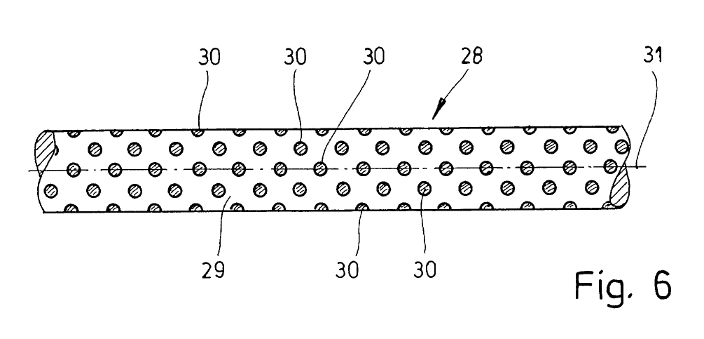

FIG. 6 shows a fourth exemplary embodiment of a submarine cable 28. This submarine cable 18 has on an outer sheath 29 a marking comprising a multiplicity of round dots 30. The dots 30 are distributed uniformly over the entire length of the submarine cable 28 along its longitudinal center axis 31 over the entire circumference of the outer sheath 29. For this purpose, in the exemplary embodiment shown, the dots 30 are arranged in a uniform grid. This is made up of a plurality of rows of dots 30, following one another at uniform intervals, the said rows extending parallel to the longitudinal center axis 16 and the dots 30 of adjacent rows being offset by half the interval between pairs of dots 30, in other words are arranged such that they are staggered. The interval between neighboring dots 30 is slightly greater than the diameter of the same. The dots 30, which are the same as one another, have in each case a diameter of preferably 1 to 10 mm. The interval between the dots 30 may also be greater than their diameter; preferably, the interval between the dots 30 is five to twenty times as great as their diameter.

While the outer sheaths of the submarine cables shown are black, the markings, in other words the longitudinal strips 13, 17, 18, 21, 22, 23, 24, or the dots 30, have a lighter color. The longitudinal strips 13, 17, 18, 21, 22, 23, 24 or the dots 30 are made yellow. This may be a shade of yellow that has fluorescent or retroreflective properties.

It is also conceivable to provide in particular the submarine cables 14, 20 with a plurality of longitudinal strips 17, 18, or longitudinal strips 21, 22, 23, 24, respectively, as shown in FIGS. 1 to 5. The individual longitudinal strips 17, 18, 21, 22, 23, 24 may also be provided with different colors, which however are to be significantly lighter than the block color of the outer sheaths. The dots 30 on the outer sheath 29 of the submarine cable 28 may be of different colors.

The markings are continuously applied to, can be integrally attached to, or can be formed along with the outer sheaths of the submarine cables while they are being produced, or are made in the outer sheaths. This may take place during or after the production of the respective outer sheath. In a first example, the markings can be continuously applied to the outer sheaths as a separately applied coating. In a second example, the markings can be integrally attached to the outer sheaths by melting both the markings and the outer sheath or by sintering the markings onto the outer sheath during application, forming a generally single outer sheath having the markings integrally formed therein. This is especially practical when the markings and the outer sheaths are made of the same or very compatible materials. In a third example, the markings and the outer sheath can be coextruded thus forming a generally unitary outer sheath with integral markings, as discussed in more detail below.

In the first example, after the production of the respective outer sheath, the marking may be printed or spayed onto the outside of the respective outer sheath in the form of longitudinal strips 13, 17, 18, 21, 22, 23, 24 or dots 30. In this case, the marking is formed from a coating of a corresponding color or from liquid plastic. The coating or liquid plastic must be of such a nature that it adheres well to the outer sheaths and is indelible, even in salty seawater.

In the second example, it is also conceivable to produce the marking by sintering onto the respective outer sheath. This also takes place preferably after the production of the outer sheath. In this case, the sintering-on can be performed while the outer sheath has not yet fully cured.

In the third example, the marking may also be produced during the production of the respective outer sheath of the submarine cable, by the respective outer sheath being formed from plastics of different colors. Then the outer sheath is formed, for example by coextrusion process, simultaneously from the black plastic and the differently colored, for example yellow, plastic for forming the marking, in particular the longitudinal strips 13, 17, 18, 21, 22, 23, 24.

The longitudinal strips 13, 17, 18, 21, 22, 23, 24 shown in FIGS. 1 to 5 extend continuously over the entire length of the respective submarine cable, in other words snake constantly, that is to say repeatedly or many times, around the outer sheath.

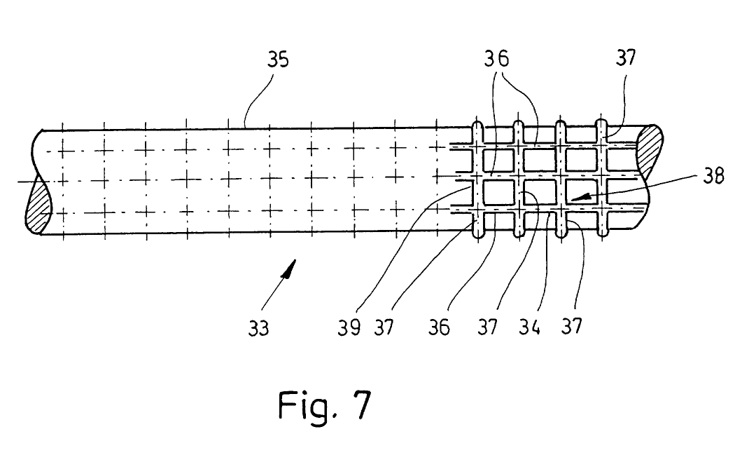

FIG. 7 shows a submarine cable 33 in which the marking is formed by a netting 34. The netting 34 surrounds the outer sheath 35 of the submarine cable 33. In the exemplary embodiment shown, the netting is formed by longitudinal strands 36, extending in the longitudinal direction of the submarine cable 33, and transverse strands 37, directed transversely to the longitudinal strands 36, which surround the outer sheath 35 uninterruptedly. In the present case, the interval between pairs of neighboring, parallel longitudinal strands 36 is approximately the same size as the interval between two neighboring, parallel transverse strands 37. As a result, rectangular opening 38 are created between the longitudinal strands 36 and the transverse strands 37. It is also possible, however, to choose the intervals between neighboring longitudinal strands 36 to be less than or greater than the intervals between neighboring transverse strands 37. Similarly, the longitudinal strands may also extend obliquely with respect to the longitudinal axis of the submarine cable 33 or wrap around it in a serpentine manner. Such longitudinal strands are also joined by transverse strands, which, if appropriate, may extend obliquely with respect to the longitudinal axis of the submarine cable 33 in order that they intersect the longitudinal strips at right angles.

The longitudinal strands 36 and the transverse strands 37 intersect at nodes 39. At these nodes 39, the longitudinal strands 36 are at the same time integrally joined to the transverse strands 37. The longitudinal strands 36 and the transverse strands 37 preferably have round cross sections of the same size.

The netting 34 is applied to the outer sheath 35 after the said sheath has been produced. For this purpose, after extrusion of the outer sheath 35 onto the core of the submarine cable 37, the netting 34 is extruded onto the outside of the outer sheath 35 in a second extrusion step.

The netting 34 and the outer sheath 35 are preferably formed from plastic, in particular an identical plastic. With regard to color, the netting 34 differs from the outer sheath 35. For example, the netting 34 is of a yellow color, if appropriate with fluorescent properties, while the outer sheath 35 is black. The opening 38 between the longitudinal strands 36 and the transverse strands 37 then appear black, while between neighboring openings 38 there is the yellow marking formed by the longitudinal strands 36 and the transverse strands 37.

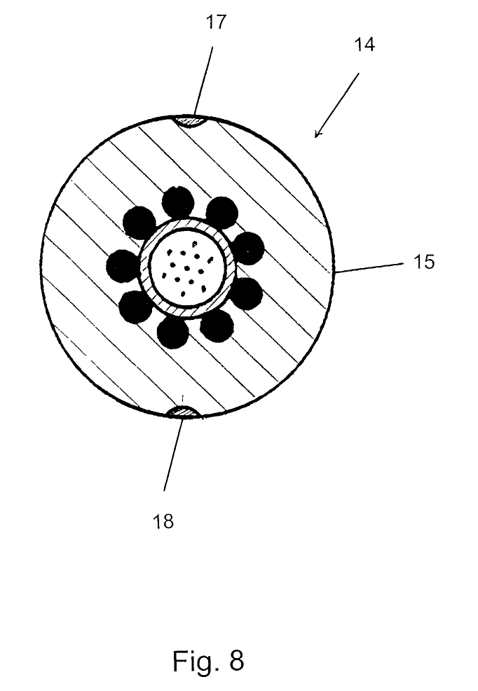

FIG. 8 shows a cross-sectional view of submarine cable 14 according to the second exemplary embodiment of the invention as shown in FIG. 2 along the sectional line 8-8′. As shown, the longitudinal strips 17, 18 run within the outer sheath 15. Such markings are continuously applied to the outer sheaths of the submarine cables while they are being produced, or are made in the outer sheaths. This may take place during or after the production of the respective outer sheath, by for example, coextrusion. Likewise, longitudinal strip 13 and outer sheath 11 as shown in FIG. 1, longitudinal strips 17, 18 and outer sheath 15 as shown in FIGS. 2 and 3, longitudinal strips 21, 22, 23, 24 and outer sheath and outer sheath 25 in FIGS. 4 and 5, dots 30 and outer sheath 29 as shown in FIG. 6, and netting 34 and outer sheath 35 as shown in FIG. 7 can be produced in the same manner.

In the exemplary embodiment shown in FIG. 8, longitudinal strips 17, 18 and outer sheath 15 preferably are coextruded. That is, longitudinal strips 17, 18 and outer sheath preferably are extruded simultaneously or contemporaneously either in a coextruder or in two extruders operating in series with each other. Further, longitudinal strips 17, 18 and outer sheath preferably also are made from the same or highly compatible materials. By using a coextruder or two extruders in series, longitudinal strips 17, 18 and outer sheath 15 are formed simultaneously or contemporaneously, thus forming a generally single or unitary cable exterior comprising longitudinal strips 17, 18 and outer sheath 15. More specifically, during the extrusion process, when longitudinal strips 17, 18 and outer sheath 15 are extruded, they are combined when each is still in the melted state and therefore when they cool, they form a generally single or unitary cable exterior. By using the same or highly compatible materials for longitudinal strips 17, 18 and outer sheath 15, the cable exterior has even a higher structural integrity as the longitudinal strips 17, 18 and outer sheath 15 will form a cable exterior being either a single material of two colors or two highly compatible materials of two colors.

As a departure from the exemplary embodiments shown, the markings may take any other desired form. From example, transverse strips, longitudinal strips that extend parallel to the longitudinal center axis of the submarine cable or dots with square or non-round surface areas may be used. It is also conceivable to form the longitudinal strips or other strips by a row of dots following one another at short intervals or to interrupt the continuous longitudinal or transverse strips occasionally. In addition, it is conceivable to vary the number of longitudinal strips as desired or to combine longitudinal strips and dots with one another.

The above detailed description of the preferred embodiments and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. Underwater cable, with a cable core having at least one conductor, and an outer sheath, characterized in that the outer sheath has at least one externally visible marking, which is a color differing and standing out from the color of the outer sheath and which is formed contemporaneously with the outer sheath during the production of the outer sheath.

2. Cable according to claim 1, characterized in that the marking is formed on the outer sheath by coextrusion.

3. Cable according to claim 2, characterized in that the outer sheath is a plastic.

4. Cable according to claim 3, characterized in that the at least one marking is a plastic.

5. Cable according to claim 4, characterized in that the outer sheath and the at least one marking are the same plastic.

6. Cable according to claim 4, characterized in that the outer sheath and the at least one marking are different but compatible plastics.

7. Cable according to claim 4, characterized in that the at least one marking is selected from the group consisting of a single strip extending spirally around the cable, at least two strips extending spirally around the cable in the same direction so that they do not cross, at least two strips extending spirally around the cable in two directions so that they cross forming nodes, dots, and nettings consisting of a plurality of crossing strips.

8. Cable according to claim 2, characterized in that the at least one marking and the outer sheath are coextruded using a coextruder.

9. Cable according to claim 2, characterized in that the at least one marking and the outer sheath are coextruded using two single extruders.

10. Cable according to claim 2, characterized in that the at least one marking and the outer sheath are coextruded resulting in a cable having an outer sheath with at least one marking that is an integral part of the outer sheath.

11. Underwater cable, with a cable core having at least one conductor, and an outer sheath having at least one externally visible marking that is a color differing and standing out from the color of the outer sheath, characterized in that the outer sheath and the at least one marking are formed contemporaneously with each other, the outer sheath and the at least one marking are made of identical or compatible plastics, and the outer sheath and the at least one marking are coextruded.

12. Cable according to claim 11, characterized in that the outer sheath and the at least one marking are the same plastic.

13. Cable according to claim 11, characterized in that the at least one marking is selected from the group consisting of a single strip extending spirally around the cable, at least two strips extending spirally around the cable in the same direction so that they do not cross, at least two strips extending spirally around the cable in two directions so that they cross forming nodes, dots, and nettings consisting of a plurality of crossing strips.

14. Cable according to claim 11, characterized in that the at least one marking and the outer sheath are coextruded using a coextruder.

15. Cable according to claim 14, characterized in that the at least one marking and the outer sheath are coextruded using two single extruders.

16. Cable according to claim 15, characterized in that the at least one marking and the outer sheath are coextruded resulting in a cable having an outer sheath with at least one marking that is an integral part of the outer sheath.

17. A method for making the underwater cable as claimed in claim 11, comprising the steps of:
a. loading a first material of a first color into a first extrusion path for producing the outer sheath for the cable;
b. loading a second material of a second color into a second extrusion path for producing the at least one marking, wherein the second color is different and stands out from the first color;
c. extruding the first material over the cable core; and
d. contemporaneously extruding the second material over the first material,
thereby resulting in the cable having an outer sheath having at least one externally visible marking that is a color differing and standing out from the color of the outer sheath.

18. The method as claimed in claim 17, wherein the first material is extruded over the cable core and the second material is extruded over the first material using a coextruder.

19. The method as claimed in claim 17, wherein the first material is extruded over the cable core and the second material is extruded over the first material using two extruders in series with each other.

20. The method as claimed in claim 17, wherein the at least one marking is extruded in the form of a shape selected from the group consisting of a single strip extending spirally around the cable, at least two strips extending spirally around the cable in the same direction so that they do not cross, at least two strips extending spirally around the cable in two directions so that they cross forming nodes, dots, and nettings consisting of a plurality of crossing strips
